(19) United States
(12) Patent Application Publication
(10) Pub. No.: US 2010/0226261 A1
(43) Pub. Date: Sep. 9, 2010

(54) METHOD AND SYSTEM TO PREVENT SPAM OVER INTERNET TELEPHONY

(75) Inventor: Christopher PICHE, West Vancouver (CA)

Correspondence Address: FASKEN MARTINEAU DUMOULIN LLP, 2900 - 550 Burrard Street, VANCOUVER, BC, V6C 0A3, CA

(73) Assignee: Eyeball Networks Inc., West Vancouver, BC (CA)

(21) Appl. No.: 12/067,168

(22) PCT Filed: Sep. 18, 2006
(86) PCT No.: PCT/CA06/01539

§ 371 Date: Oct. 15, 2008

Related U.S. Application Data
(60) Provisional application No. 60/717,239, filed on Sep. 16, 2005.

(51) Int. Cl. H04L 12/26; H04L 12/66; G06F 21/00

(52) U.S. Cl. 370/252; 370/352; 726/26

(57) ABSTRACT

A method and system of preventing SPAM over Internet telephony (SPIT) is provided, including the establishment of calling rate limits for VoIP Challenge for callers, and SPIT ratings included with call initiation manual input messages to warn the callee if the call is at high risk of being SPIT. The calling rate limits are adjustable based on the reputation of the caller and events which may occur that are indicative of SPIT. Furthermore, methods for parental control over call end-points are provided.

The application claims the benefit of U.S. Provisional Patent Application No. 60/717,239 filed Sep. 16, 2005, which is hereby incorporated by reference.

### FIELD OF THE INVENTION

The invention relates to methods of preventing SPAM, and more particularly, to methods of preventing SPAM in the field of Internet based telephony.

### BACKGROUND OF THE INVENTION

Voice-over-IP (VoIP) is the routing of voice conversations over the Internet or through any other IP-based network. VoIP is a substitute for traditional telephone service offered by public switched telephone networks (PSTN).

VoIP is becoming adopted widely by both businesses and residential customers. VoIP uses standard and open protocols such as Session Initiation Protocol (SIP) and Real-time Transport Protocol/User Datagram Protocol (RTP/UDP) for voice and video call establishment and data transfer. Using open standards for VoIP makes users vulnerable for the various security problems already occurring in common Internet applications. These vulnerabilities include: bulk and unsolicited calls for telemarketing, advertising and other commercial purposes; unwanted calls from strangers from anywhere in the world at undesirable times; harassment and abuse such as repeated automated calls; and exposure to unacceptable content such as pornography or offensive language in calls received from strangers (an important issue, particularly when involving children).

In this document the term VoIP “SPAM over Internet telephony” (SPIT) refers to the problems described above and the term “spitter” refers to VoIP users sending SPIT. It is noteworthy that if VoIP SPIT cannot be prevented it may victimize telephone users, including traditional telephony users (i.e. PSTN and mobile phone users).

Over two-thirds of the emails sent through the Internet currently represent spam emails, and if proper measures are not taken against SPIT, it may become a worse problem than the current email SPAM problem, as VoIP calls require real-time attention from callees and, in a worst case scenario, SPIT may make the century-old PSTN system unusable (due to the volume of SPIT calls from VoIP users).

Related art includes Rosenberg, J., Schulzrinne, H., Camarillo, G., Johnston, E., Peterson, J., Sparks, R., Handley, M., Schooler, E., “SIP: Session Initiation Protocol”, IETF RFC 3261; Tschofenig, H., Polk, J., Peterson, J., Sicker, D., Tegnander, M., “Using SAML for SIP”, IETF Internet Draft. draft-tschofenig-sip-saml-03, work-in-progress, July 2005; Schwartz, B., Sterman, B., Katz, E., “Proposal for a SPAM for Internet Telephony (SPIT) Prevention Security Model”, Kayote Networks, Inc.; Sparks, R., “The Session Initiation Protocol (SIP) Refer Method”, IETF RFC 3515; Peterson, J., Jennings, C., “Enhancements for Authenticated Identity Management in the Session Initiation Protocol”, IETF Internet Draft. draft-ietf-sip-identity-05, work-in-progress, March 2005; Rosenberg, J., Jennings, C., Peterson, J., “Identity Privacy in the Session Initiation Protocol (SIP)”, IETF Internet Draft, draft-rosenberg-sip-identity-privacy-00, work-in-progress, July 2005; Reid, P. “Voice Spam Spam, Spamity Spam”, Qovia, Inc., White Paper, June 2004; and SpamAssassin. http://spamassassin.apache.org/ (last visited: Aug. 4, 2005).

Prior art covers only a small set of detection mechanisms for SPIT, basically related to either the call frequency and the duration of calls (see Reid, P. “Voice Spam Spam, Spamity Spam”, Qovia, Inc., White Paper, June 2004). However, the call frequency of callers alone cannot be used as a reliable metric for the detection of SPIT. For example, call centers likely generate a) high volume of calls but do not necessarily deliver SPIT.

In order to filter incoming messages or calls, end-point software may use blacklist and whitelist mechanisms. This enables a callee to define call sources, which are completely blocked (blacklisted) or always accepted (whitelisted). However, a drawback of these mechanisms is the strict enforcement of the rules defined by the blacklist/whitelist. For example, when accepting only calls from whitelisted call sources, other calls are completely blocked and the callee may not even be notified. Furthermore, legitimate calls from other than whitelisted sources will not be received at all.

Rating systems for SPAM are used in the email domain, e.g., SpamAssassin provides a rating that can be used by end-point software or servers to deal with SPAM; however, the SPAM rating does not describe how to deal with such emails. Furthermore, email communication differs significantly from PSTN or VoIP calls: emails do not interrupt or disturb a receiver, whereas calls must be answered within a short period of time, otherwise, the caller will hang up.

For VoIP networks, an approach to specify an enhanced security framework based on roles and traits was proposed in Tschofenig, H., Polk, J., Peterson, J., Sicker, D., Tegnander, M., “Using SAML for SIP”, IETF Internet Draft. draft-tschofenig-sip-saml-03, work-in-progress, July 2005. The approach enables, for example, transmitting a variety of security related information about an incoming call and the respective caller (such as membership in an organization) together with the call invitation message. An adoption of such a system to provide a framework for SPIT has been outlined in Schwartz, B., Sterman, B., Katz, E., “Proposal for a SPAM for Internet Telephony (SPIT) Prevention Security Model”, Kayote Networks, Inc. The main contribution of this proposal is the description of actual application environments and an actual description of possible parameters to be added to call invitation messages, for example, descriptions of the authentication method used by the caller and the cost of the call. Furthermore, the document gives examples for embedding the proposed parameters into the framework outlined in Tschofenig et al. The framework as described in Schwartz et al. outlines a protocol for transmitting SPIT ratings but does not provide information about how to compute the SPIT rating.

### SUMMARY OF THE INVENTION

For bulk calling to be attractive to potential spitters, they are able to make a large number of calls within a short period of time. The invention provided herein describes a method and system for limiting the number of calls output from and calls received by a single user (based on routable identity such as SIP universal resource identifier (URI)) or a hardware device (based on IP or MAC address)).

In order to prevent SPIT in VoIP networks, the invention provides a SPIT prevention system for servers and end-point systems in which:
1. status information about each caller and his/her call behavior is kept and applied in an algorithm to dynamically adjust the allowed call rate for each caller. The algorithm evaluates different information stored about each caller, including the number of callee terminated short calls, and uses this information to determine a single value (referred to as a dynamic calling rate limit) for each caller;
2. an unique callee limit is used to restrict the number of different callees per caller in order to detect abnormal caller behavior;
3. an actual SPIT rating based on the dynamic calling rate limit of the caller to call invitations is determined and transmitted to callees to support callees in their decision whether or not to accept an incoming call;
4. a challenge/response mechanism is used when the calling rate limit of a caller is exceeded or is below a predefined threshold. In such a case, callers are challenged for manual input before a call invitation is forwarded to the callee. When the challenge is successfully passed, the call frequency may be increased, for example, to the initial value. Otherwise, the caller may be completely blocked;
5. a coding scheme is used on clients based on the aforementioned SPIT rating transmitted with call invitations. The coding scheme is used to signal the nature of an incoming call, i.e., how likely it is the call contains SPIT; and
6. a parental control mechanism is provided based on techniques such as calling rate limit, unique callee limit, total call duration, time-of-day, and call content monitoring (such as skin-tone filtering based on the amount of skin tone).

Consequently, the system and method described herein does not set a fixed limit for a single source (caller), but can be used with extremely high allowed call frequencies which are only changed (using the rating algorithm) in case a source (caller) shows misbehavior such as large numbers of callee terminated short calls. In addition, this system and method requires no access to the voice/video content of the call itself, but relies on the analysis of the signaling messages.

To obtain the required input data for triggering the coding scheme according to the invention, a SPIT rating provided by forwarding servers is used. A simple mechanism is provided to translate the SPIT rating, determined and added by the forwarding server to an incoming message, into a user-friendly representation, which puts a callee in a position to decide quickly whether or not the call is worth answering.

A method of limiting the number of unique callees for a caller on a VoIP network is provided, including the steps of: (a) identifying said caller; establishing a dynamic calling rate limit for said caller; and if said caller exceeds said dynamic calling rate limit, challenging said caller. An end-point used by the caller may be identified using an SIP URI, an IP address, and/or a MAC addresses associated with the caller. After challenging the caller by providing a puzzle, and if said caller does not solve said puzzle, the call is blocked.

A method of determining a dynamic calling rate limit of a VoIP caller is provided, including: (a)) providing an initial calling rate limit; (b) establishing an initial value for the dynamic calling rate limit by adjusting the initial calling rate limit using a reputation value associated with the VoIP caller; (c) after each incident associated with SPIT associated with the caller, adjusting the value of the dynamic calling rate limit by multiplying said value of the dynamic calling rate limit by a value between 0 and 1; and (d) after passage of a predetermined period of time, adjusting the >value of said dynamic calling rate limit by dividing the value of the dynamic calling rate limit by a value between 0 and 1. The incident associated with SPIT may include a value associated with the callee having a number of callee terminated calls of short duration; a value associated with the callee having a report made alleging the callee has engaged in SPIT; and/or a value associated with the callee having a number of calls of short duration. If the callee initiates a call) in excess of the value of the dynamic calling rate limit, the callee is challenged.

A method of determining if a VoIP call initiation from a caller to a callee is SPIT is provided, including: (a) establishing a value related to a relative calling rate limit and a value corresponding to a relationship between the caller and the callee; and (b) if the value exceeds a predetermined threshold, providing a warning to the callee that the call initiation is likely to be SPIT. The relative calling rate is determined by dividing a dynamic calling rate limit by an initial calling rate limit. The value corresponding to the relationship between the caller and the callee may be related to a whitelist maintained by the callee or a blacklist maintained by the callee; and the history of calls between the caller and the callee. The warning is provided using visual signals or audio signals.

A system for preventing SPIT is provided, including a server; an end-point associated with a caller; a second end-point associated with a callee; wherein the server calculates a dynamic calling rate limit for the caller, and challenges calls from the caller to the callee that exceed the dynamic calling rate limit. The server computes a rating for a call between the caller and the callee and adds the rating to a call invitation message from the caller to the callee. The second end-point may use a visual or audio signal to warn the callee if the rating exceeds a predetermined value. A value related to the callee-caller relationship may modify the rating.

A method to provide parental control for an end-point is provided, including permitting calls only to and from a whitelist; restricting incoming and outgoing calls to a pre-defined period; limiting a time in which the end-point is available for calls during a fixed time period; and restricting the number of calls made within said time period. Alternatively, calls to a from a blacklist may be restricted. If the end-point is a video phone video calls may be restricted based on the amount of skin-tone present within the video of said calls.

### BRIEF DESCRIPTION OF THE DRAWINGS

FIG. 1 shows sample functions to adjust the dynamic call frequency according to the invention;

FIG. 2 is a flow chart of a challenge/response mechanism according to the invention;

FIG. 3 is a block diagram showing the main factors, parameters and outcomes of an anti-SPIT algorithm according to the invention;

FIG. 4 is a graph showing sample functions η between SPIT-rating and caller-callee relationship according to the invention; and

FIG. 5 is an example of SPIT notification at an end-point using a color-coding scheme according to the invention.

### DETAILED DESCRIPTION OF THE INVENTION

A communication system such as PSTN or a VoIP system consists of two main components, a server system maintained by one or more service providers and a plurality of end-points used by customers (residential or business) of the service providers (referred to as “end-users”). An end-point may be a hardware telephone, a hardware videophone, a TV phone, or a software phone or messenger. The term “phone” or “telephone” herein refers to both hardware connected via PSTN or other land lines and cellular phones. In a preferred embodiment, a VoIP or video telephony system includes a server system able to forward “good” calls and block SPIT, while flagging suspicious calls before they are forwarded; and the end-points should be able to provide robust, simple and flexible means to protect end users from SPIT calls.

In a preferred embodiment, service providers assume the policing responsibility for blocking or filtering SPIT calls, while end-points are not trusted to prevent SPIT calls—although the vast majority of the end-users will not be spitters, it cannot be guaranteed that their systems (such as PCs and VoIP-phones) will not be hacked by spitters. Preferably, end-users may (and will be willing to) help the service providers in proper filtering of calls received; and some of the end-points will be “smart” devices with rich user interfaces and processors while others will be “dumb” devices such as analog telephones.

Furthermore, in a preferred embodiment of a VoIP network, end-points preferably have one or more of the following features:
Valid calls from other users are not blocked;
Callees have an easy and simple way to avoid SPIT calls and bad content (such as using green, yellow and red color coding);
Users may set call filters based on validated user IDs, geographic location of callers, time of day, and other factors;
User interaction to avoid SPIT is minimal; and
Parental control mechanisms are present to restrict call sources, destinations, total calling time, time-of-day, and call content, in particular for video calls.

In a preferred embodiment of a VoIP network, the server systems preferably have the following features:
Dynamic monitoring and control of the voice service provided and prevention of SPIT;
Preventing bulk unsolicited calling (using techniques such as calling rate limit, unique callee limit in a given period, and others);
Marking suspicious calls with a SPIT rating; and
Blocking calls from non-complying callers.

The different methods, techniques and system to prevent SPIT according to the invention, follow.

### Caller Identification

A first tool to prevent spitting is to identify callers. In an actual VoIP service, callers can be identified and distinguished by their network address, which must be included in the call invitation in order to successfully establish a call. For example, in SIP (see Rosenberg, J., Schulzrinne, H., Camarillo, G., Johnston, E., Peterson, J., Sparks, R., Handley, M., Schooler, E., “SIP: Session Initiation Protocol”, IETF RFC 3261), IP address information is usually included in via or contact headers. In addition to addresses of network end-points, caller identification can also be determined using trusted certificates or other reliable information about a caller's identity. For example, the system according to the invention can be used with an enhanced SIP that incorporates authenticated identity management (see Peterson, J., Jennings, C., “Enhancements for Authenticated Identity Management in the Session Initiation Protocol”, IETF Internet Draft. draft-ietf-sip-identity-05, work-in-progress, March 2005).

In the system according to the invention, a method and system is provided to prevent spitting from those callers designated as “bad” callers or groups of “bad” callers. A caller may be designated as “bad” and identified or blocked based on identifiers such as the caller's authenticated user ID, their SIP URI (e.g. abc@xyz.com), network IP address (such as 205.123.25.24), hardware MAC address, or source calling domain (such as SIP URI domain xyz.com), although other identification means may be used.

The servers within the system can monitor callers and block those that behave in a manner suggestive of spitting, and in extreme cases can block entire domains. End-users can be used to block identified callers as well, using end-points, for example by blocking all calls from a particular callee using the above described identifiers.

Using a generic scheme for identifying call sources, it is possible to monitor and limit, not only individual callers, but also proxies or groups of callers behind firewalls or NAT devices. In addition, the use of anonymizing proxies is considered. Anonymizing proxies refers to proxies used to disguise the actual identity of callers by removing any information that may reveal location or identity such as IP address, name, etc. from messages and message headers.

The term caller in this document refers to individuals, groups of persons, network addresses or groups of network addresses, such as network domains, or any other type of identification suitable to uniquely distinguish and identify the call initiator of a VoIP system. For example, this type of identification may mean the geographical location of the caller. Users are individuals, groups of persons, network addresses or groups of network addresses, such as network domains, or any other type of identification suitable to uniquely distinguish and identify users of a VoIP system, that may be callers or callees, as the situation warrants.

### Unique Callee Limit

A large number of different callees called by a single identified caller is an indicator of possibly abnormal call behavior, such as SPIT calls. For example, if a residential end-user (the caller) tries to call more than 1000 unique callees in a given month, there is a reasonable likelihood that this caller is making bulk calls (perhaps using an automated calling system fed by a list of callees). For this purpose, a unique callee limit is preferably introduced for each caller. The unique callee limit should accommodate for changes in a caller's behavior or social environment, and therefore, the callee limit can be complemented with a duration parameter. As an example, the unique callee limit can be initially set to a very high number, for example one thousand (1000) different callees per month. This high callee limit should be sufficient for average end-users but insufficient to successfully carry out SPIT calls. Preferably a call history kept by a server to implement this limitation, and such call history can also be used to identify the relationship between caller and callee to determine the reputation of a particular caller, as described below.

The unique callee limit can be individually adjusted in order to cope with different requirements of callers, users and user groups. In particular, a unique callee limit can be assigned to a single network address or network domain.

Tracking caller-callee calls and rates is technically feasible. For example, if a service has one million end-users, and the maximum unique callee limit is set to one thousand (1000) in a given month, then the upper limit for the size of storage for tracking caller-callee relations is one billion entries, and may, of course, be less, as typical callers will likely use less than 10% of the maximum unique callee limit. In addition, the statistics gathered to monitor the unique callee limit can be used for other purposes such as determining the relationship between two parties as used in the computation of the SPIT rating as described below.

### Dynamic Calling Rate Limit

Part of the SPIT protection system and method according to the invention is an algorithm for computing a dynamic calling rate limit for VoIP callers. As an example, suppose a user has a calling limit of fifteen (15) calls in a period of three hundred (300) seconds. Then the server within the system will permit fifteen (15) calls from this user within such time period. For calls exceeding this calling rate, the server may challenge the caller for additional validation. Preferably, the calling rate limit is adapted dynamically in order to deal with the different requirements of various users and user groups. The calling limit should be high enough so that typical callers are not affected (they may not even know that such a limit exists), but should be low enough to make commercial spitting infeasible or unattractive. Therefore, instead of choosing a static limit for each end-user individually, it is useful to assign high initial calling rate limit to each end-user and reduce them when suspicious call behavior is detected.

A dynamic calling rate limit algorithm based on monitoring and evaluating various events related to a caller's behavior, i.e., suspicious call patterns, is preferably used. The adaptation of the calling rate limit for a caller is triggered by the following events, factors, and call patterns:
i. Short calls in a given period: SPIT calls are assumed to be short;
ii. Callee terminated short calls in a given period: callees are expected to terminate SPIT calls after a short period of time;
iii. Caller's reputation (including reputation of caller's domain or organization): certain callers or domains may have a history associated with spam or SPIT, and are thus likely to convey SPIT;
iv. Call-validated SPIT reports: end-users can report SPIT incidents. After a validation, SPIT reports are added to a caller's history;
v. Calls to unknown destinations: excessive call attempts to callees that do not exist indicates dictionary or directory “attacks”, i.e. calls based on a list of numbers;
vi. Callee-caller relationship (friendliness factor): persons which have a long call history or have each other whitelisted can call each other independent of their dynamic calling rate limit; and
vii. Inactivity or good call periods: during inactivity periods, the calling rate limit may recover from previous incidents.

The impact of each of these factors can be adjusted individually to reflect the importance of the actual event in the given setting. In particular, it is possible to obtain different values for the same event depending on the actual application environment. A preferred algorithm to compute the dynamic calling rate limit of a caller is as follows:

### Dynamic Calling Rate Limit Algorithm

1. Dynamic calling rate limit is designated as λ, and the initial calling rate limit is designated as L, where L is expressed in calls/second.
2. The initial value of the dynamic calling rate limit is: λ=L*γ (where y is a reputation factor).
3. After each incident considered “bad” (indicative or possibly SPIT): λ=λ*ρ with ρε[0 . . . 1], where
   ρ will vary for different incidents such as:
      i. callee terminated short calls;
      ii. short calls; or
      iii. call-validated SPIT report (affects caller's reputation).
4. For each period T, of no activity or “good” calls: λ=λ/ρ′ or L, whichever is smaller.

In the algorithm set out above, the actual call frequency used to detect whether or not to block or question a future call is denoted with λ, and ρ denotes the “weight” of each “bad” incident. For example, ρ will be set to a value close to one (1) for incidents which are undesirable but may be pure coincidence, such as short calls. In contrast, ρ will be set close to zero (0) for incidents which are significant and indicate SPIT calls such as validated SPIT-reports received from callees. The initial value L will typically be adjusted by the VoIP network operator to reflect various requirements of callers, e.g., to provide different call limits for individuals and corporate customers or for groups and single callers.

As an example, suppose a given caller has an initial calling rate limit L of ten (10) calls per one hundred (100) seconds, i.e., L=10/100=0.1. Also, let us suppose the reputation (γ) of the caller is γ=1. Therefore, the dynamic calling rate limit λ, is initially set to λ=L*γ=0.1*1=0.1. Assuming, this caller makes five short calls terminated by the callees and one call to an unknown callee. The “penalty” ρ₁ for callee terminated short calls is set at ρ₁=0.9 and the penalty ρ₂ for calls to unknown callees is set as ρ₂=0.99. Thus, after making five (5) callee terminated short calls and one call attempt to an unknown callee, the dynamic calling rate limit λ is given as follows:

λ=0.1*ρ₁⁵*ρ₂¹≈0.1*0.59*0.99≈0.058.

In this example then, the dynamic calling rate limit for that caller is reduced to approximately six (6) calls per one hundred (100) seconds.

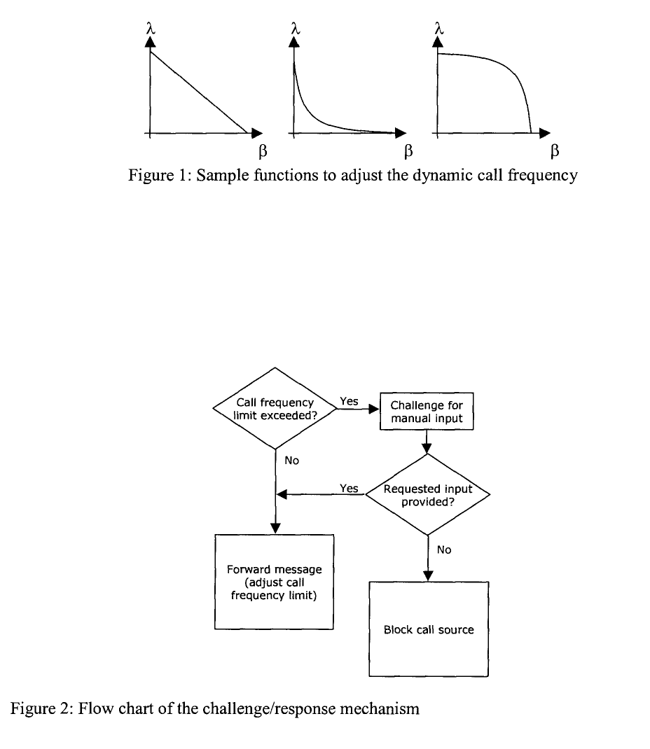

Depending on the choice of the parameters ρ, which may have different values for each event, and the combination of the parameters into a single calling rate limit, a variety of different behaviors of λ can be achieved. Three examples are depicted in FIG. 1, showing the relation of λ depending on the number of “bad” incidents β. In fact, it is possible to obtain different behaviors depending on the actual incident. For example, one incident may generate a linear curve whereas another results in exponential decrement of λ. Thus, the resulting function for λ is a mixture of the function generated by each parameter ρ.

### Challenge/Response Mechanism

To avoid the strict blocking of callers or network addresses and hence reducing the number of “false alarms” (false positives or unjustified blocking), in a preferred embodiment of the invention, a challenge/response mechanism is employed when the dynamic calling rate limit is reached. Once the server processing a new call invitation detects that the caller has exceeded its dynamic calling rate limit, the server intercepts the call, by answering the call and asking for input or identification. The caller is then sent a voice or video message explaining what needs to be done to proceed with the original call (the challenge). The challenge can consist of one or more tasks to fulfill and will usually include some sort of puzzle which can be easily solved by a human but is difficult to solve by a computer, for example, the caller may be requested to type a sequence of numbers on his/her keypad. An automated caller will usually be unable to fulfill the requested task and thus, the call will be blocked. To improve the mechanism and make the task more difficult for automated callers, background noise can be added to the message from the server.

After a satisfactory response from the caller, the server then forwards the request to the original call destination. In addition, the dynamic calling rate limit can be adjusted to a higher limit. The flow chart for the challenge response mechanism is depicted in FIG. 2.

### SPIT Rating

The SPIT rating for an incoming call is computed on the server and is based on the caller's current dynamic calling rate limit. In a preferred embodiment of the invention, the SPIT rating is related to the relative calling rate limit λ/L, which is computed using the dynamic calling rate limit of the callee as described above. The SPIT rating is also related to the relationship between the caller and callee, which may be available, for example from the callee's whitelist. Both values are then combined to determine the SPIT rating:

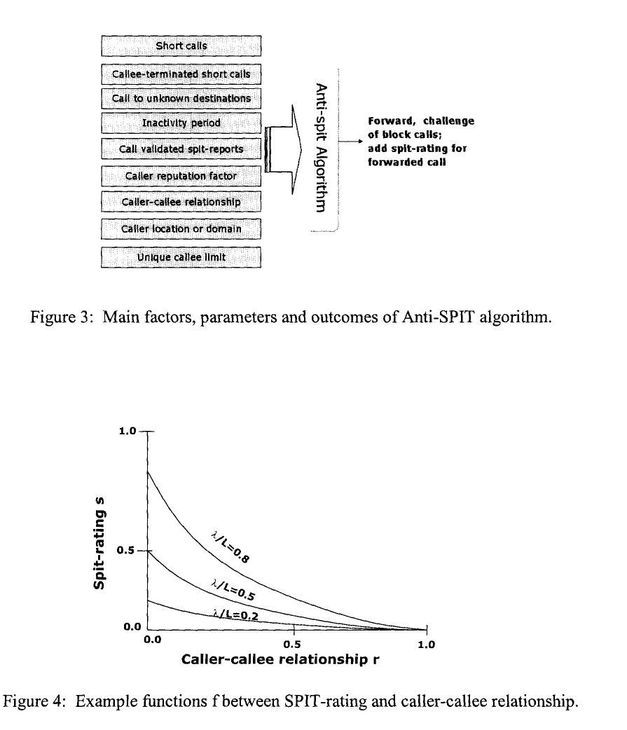

SPIT rating=f(λ/L,caller-callee relationship),

where f defines the relative impact of each of the other two values. FIG. 3 shows the different parameters influencing a preferred embodiment of the SPIT rating. FIG. 4 shows an example function, which may be used to compute SPIT-rating using the calling rate limit and the caller-callee relationship.

The server can use a heuristic algorithm to determine the caller-callee relationship using parameters such as the callee's whitelist and blacklist, call history between the caller and callee and the recursive usage of the “buddylist” maintained by the end-users. An example of a heuristic algorithm for determining the caller-callee relationship using call history is as follows:

$$\begin{matrix}r ( A , B ) = 1 if caller A is on whitelist of callee B , \\ = 0 if A is on blacklist of B , \\ = v , where v = 0.2 + d \text{/} D , and if v > 1 then v = 1.\end{matrix}$$

Here d is the total minutes of calls between A and B, and D is a threshold duration. Using this formula, and supposing D=100 minutes, then if A and B had already had calls with each having a total duration of thirty (30) minutes, r(A,B) will be 0.5.

The SPIT rating is added to each call invitation and transmitted to end-points, where it is used to trigger the coding scheme as described below.

### Coding Scheme

Preferably, a simple and easy-to-use mechanism is provided to enable callees to handle incoming calls which may contain undesired content such as SPIT. The SPIT rating provided by the server is used as a foundation for notifying callees of the nature of an incoming call along with the corresponding call invitation. The notification preferably uses a coding scheme to enable callees to determine whether or not an incoming call is likely to contain SPIT. Callees are notified of possible dangers or undesired messages when receiving a voice or video call. The possibility that a call contains SPIT is provided to the callee, while leaving the actual choice as to whether or not to take the call to the callee. In a preferred embodiment, callees can define rules for blocking incoming calls using a coding scheme implemented in their VoIP end-point software.

For example, time-of-day dependent mechanisms can be implemented, automatically redirecting certain messages received during the night to a voice mailbox.

### Color Coding

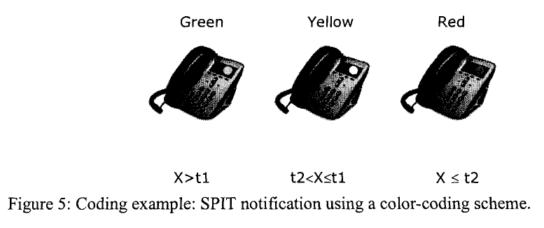

Such a coding scheme for callees can be implemented using color codes. For example, assuming a SPIT rating of Xε[0 . . . 1] (as provided by a server forwarding the call, for example), two thresholds t1ε[0 . . . 1] and t2ε[0 . . . 1] can be selected. These thresholds, t1 and t2, define which values of X trigger a green, yellow, or red light, respectively (see FIG. 5). The callee then gets a visual representation of the “risk” that a call is SPIT, and can choose to accept the call accordingly.

It is useful to have only a small number of different colors for the notification, for example, a green light for identification of “good” calls, e.g., from whitelisted callers independent of the server SPIT rating; a yellow light for calls which are not on the whitelist but have a SPIT rating below a certain threshold from the forwarding server; and a red light for calls which are not whitelisted and have a SPIT rating above the given threshold. Such an example only requires a single threshold, t1.

Alternatively, if two thresholds, t1 and t2 are selected, a green light may be used for calls in which the SPIT rating is less than or equal to t1; a yellow light for calls having a SPIT rating greater than t1 and less than or equal to t2; and a red light for calls having a SPIT rating greater than t2.

### Ring Tone Coding

Ring tones are an alternative means of signaling the SPIT rating of incoming calls. In such a case, a different tone or volume can be selected, depending on the parameters of the incoming call. For example, the same thresholds as described above can be used to trigger different ring tones instead of color coding.

### Spit-Reporting, Skin-Tone Filtering and Caller Reputation

One inputs or parameters for the dynamic calling rate algorithm is related to SPIT reports or the caller reputation. This parameter covers situations in which callees report a caller for an unsolicited call or inappropriate content. This reporting may be done manually by a simple “report the caller for SPIT” button at the end-point, or may be done automatically by “smart” end-points.

End-points may also be able to use a skin-tone filter to block pornographic content in video calls (perhaps using some parental control or decency control interface) based on the amount of skin tone present. If the end-point software detects reception of pornographic content, it may stop displaying the pictures, and automatically report the incident against the caller along with 2-3 snapshots of the triggering content which will then affect the caller's reputation and consequently, the callers's dynamic calling limit.

### Parental Control

The SPIT prevention techniques described above may also be used to provide parental control features to protect children from strangers and inappropriate content. A few filters that parents may enable include:
Calls only to and from a whitelist: Parents can define a whitelist of users for incoming and outgoing calls. People outside this list cannot call and cannot be called. It is possible to restrict calls based on the caller's phone numbers, caller IDs, IP addresses, locations, etc.
Time-of-day: Parents can enable time-based call filtering to prevent calls being received or sent during certain times. For example, parental control features may be automatically turned on during work days (between 9 AM and 5 PM, Monday to Friday), when parents are not at home. In a similar fashion, parents may not want calls sent or received after 10 PM and before 7 AM the next day.
Total call duration: The total duration, of a set of calls or a single call may be limited. The actual implementation for restricting the call duration can include a variety of possible filters, such as limiting the duration of a single call, limiting the accumulated duration of the calls carried out within a single period, such a day, a week, or whatever period is desired. In addition, this filter may include a limitation based on the number of calls received or sent within such predefined period.
Skin-tone filtering: In order to prevent video calls with adult or offending content to reach customers, a skin-tone detection mechanism may be employed on end-points to determine the amount of skin tone present in a call. The mechanism filters the call content of a video call for suspicious call patterns and can be combined with an automatic SPIT-reporting mechanism as described above.
Language filtering: In a similar fashion to skin tone filtering, and end-point according to the invention may include voice recognition software, and on hearing the utterance of certain words or phrases, may terminate the call, and “blacklist” the callee.

The management of the parental control mechanisms may be protected from unauthorized access, for example, by using a password mechanism or other means known in the art such as biometrics.

The parental controls can be implemented on either the server or the end-points or a combination of both. Since filtering mechanisms are preferably already implemented in the server component of the SPIT prevention system as described above, it is easy to implement filtering call destinations, time-of-day limitations, and call duration limitations in the server component. In contrast, the content itself is usually not sent through a server, therefore, the skin-tone filtering as described above, or language filtering should be implemented at the end-points.

### Implementation Notes

In the system and method according to the invention, preferably, the messages to be monitored by the SPIT prevention system to detect callers and SPIT-related events will be exemplified using the framework of the Session Initiation Protocol. However, the techniques are also applicable to other protocols and implementations. In a SIP-based VoIP environment, the SPIT prevention methods described in the previous sections monitor, generate or modify, in particular, the following SIP messages:
Call invitations: SIP INVITE messages are parsed on the server-side in order to obtain the source of a call and the callees called by the caller. In addition, SIP INVITE messages are used by the parental control mechanism to determine time-of-day and restrict the call destinations.
Successful call establishment: successful call establishment must be monitored to keep the caller's history lists and caller-callee relations. For this purpose, the SIP 200 Ok messages as response to INVITE messages may be monitored.
Call blocking: the server-side anti-SPIT mechanism generates a 403 Forbidden response message to indicate the dynamic calling rate limit was exceeded and no further calls are allowed until the limit has recovered.
Challenge/Response: the SPIT prevention server system intercepts SIP INVITE messages in order to challenge the caller upon exceeded calling rate limit. Upon correct response, the server redirects the caller to the callee using the SIP REFER message (see Sparks, R., “The Session Initiation Protocol (SIP) Refer Method”, IETF RFC 3515).
Call end: to detect the party who ended a call and to obtain the duration of the call (e.g. used for parental control purposes), SIP BYE messages are monitored by the server. In case the allowed total call duration is exceeded, the parental control mechanism may initiate the SIP BYE message to terminate a call.
SPIT rating: The SPIT rating is transmitted to clients as a numerical value in an additional header of the SIP INVITE message.

Although the particular preferred embodiments of the invention have been disclosed in detail for illustrative purposes, it will be recognized that variations or modifications of the disclosed apparatus lie within the scope of the present invention. The system and methods described herein could be recorded on a computer readable medium as a series of instructions for execution by one or more computers. Alternatively, the system and method described herein could be a recorded on a computer program product, for execution by a computer. Also, the methods and system described herein could be embodied as a carrier wave embodying a computer data signal representing sequences of statements and instructions which, when executed by a processor cause the processor to perform the method described herein.

I claim:

1. A method of limiting the number of unique callees for a caller on a VoIP network, comprising:
(a) identifying said caller;
(b) establishing a dynamic calling rate limit for said caller; and
(c) if said caller exceeds said dynamic calling rate limit, challenging said caller.

2. The method of claim 1 wherein, in step (a) an end-point used by said caller is identified using an SIP URI associated with said caller.

3. The method of claim 1 wherein, in step (a) an end-point used by said caller is identified using an IP address associated with said caller.

4. The method of claim 1 wherein, in step (a) an end-point used by said caller is identified using a MAC addresses associated with said caller.

5. The method of claim 1 wherein after challenging said caller by providing a puzzle, and if said caller does not solve said puzzle, blocking said call.

6. A method of determining a dynamic calling rate limit of a VoIP caller, comprising:
(a) providing an initial calling rate limit;
(b) establishing an initial value for said dynamic calling rate limit by adjusting said initial calling rate limit using a reputation value associated with said VoIP caller;
(c) after each incident associated with SPIT associated with said caller, adjusting said value of said dynamic calling rate limit by multiplying said value of said dynamic calling rate limit by a value between 0 and 1; and
(d) after passage of a predetermined period of time, adjusting said value of said dynamic calling rate limit by dividing said value of said dynamic calling rate limit by a value between 0 and 1.

7. The method of claim 6 wherein said incident associated with SPIT includes a value associated with said callee having a number of callee terminated calls of short duration.

8. The method of claim 6 wherein said incident associated with SPIT includes a value associated with said callee having a report made alleging the callee has engaged in SPIT.

9. The method of claim 6 wherein said incident associated with SPIT includes a value associated with said callee having a number of calls of short duration.

10. The method of claim 6, further comprising:
(d) if said callee initiates a call in excess of said value of said dynamic calling rate limit, challenging said callee.

11. A method of determining if a VoIP call initiation from a caller to a callee is SPIT, comprising:
(a) establishing a value related to a relative calling rate limit and a value corresponding to a relationship between said caller and said callee;
(b) if said value exceeds a predetermined threshold, providing a warning to said callee that said call initiation is likely to be SPIT.

12. The method of claim 11 wherein said relative calling rate is determined by dividing a dynamic calling rate limit by an initial calling rate limit.

13. The method of claim 11 wherein said value corresponding to said relationship between said caller and said callee is related to a whitelist maintained by said callee or a blacklist maintained by said callee; and the history of calls between said caller and said callee.

14. The method of claim 11 wherein said warning is provided using visual signals.

15. The method of claim 11 wherein said warning is provided using audio signals.

16. A system for preventing SPIT, comprising:
(a) a server;
(b) an end-point associated with a caller;
(c) a second end-point associated with a callee;
wherein said server calculates a dynamic calling rate limit for said caller, and challenges calls from said caller to said callee that exceed said dynamic calling rate limit.

17. The system of claim 16 wherein said server computes a rating for a call between said caller and said callee and adds said rating to a call invitation message from said caller to said) callee.

18. The system of claim 17 wherein said second end-point uses a visual signal to warn said callee if said rating exceeds a predetermined value.

19. The system of claim 17 wherein said second end-point uses an audio signal to warn said callee if said rating exceeds a predetermined value.

20. The system of claim 17 wherein a value related to the callee-caller relationship modifies said rating.

21. A method to provide parental control for an end-point, comprising:
(a) permitting calls only to and from a whitelist;
(b) restricting incoming and outgoing calls to a pre-defined period;
(c) limiting a time in which the end-point is available for calls during a fixed time period; and
(d) restricting the number of calls made within said time period.

22. A method to provide parental control for an end-point, comprising:
(a) restricting calls to and from a blacklist;
(b) restricting incoming and outgoing calls to a pre-defined period;
(c) limiting a time in which the end-point is available for calls during a fixed time period; and
(d) restricting the number of calls made within said time period.

23. The method of one of claim 21 or 22 wherein said end-point is a video phone and said method further comprises:
(e) restricting video calls based on the amount of skin-tone present within the video of said calls.
